(19) United States
(12) Patent Application Publication
(10) Pub. No.: US 2006/0162613 A1
(43) Pub. Date: Jul. 27, 2006

(54) Reduction-stable zinc ferrite pigments, process for producing them and their use

(76) Inventors: Carsten Rosenhahn, Krefeld (DE); Udo Krauter, Leverkusen (DE); Ralf-Gerhard Konig, Dusseldorf (DE)

Correspondence Address: LANXESS CORPORATION, 111 RIDC PARK WEST DRIVE, PITTSBURGH, PA, 15275-1112, US

(21) Appl. No.: 11/330,513

(22) Filed: Jan. 12, 2006

(30) Foreign Application Priority Data
Jan. 25, 2005 (DE) 10 2005 003 356.3

(51) Int. Cl. C09D 11/00; C03C 8/14; C09C 1/22; C04B 16/00; C01G 49/00; C01D 1/02; C08K 3/22

(52) U.S. Cl. 106/31.9; 106/456; 423/594.2; 423/594.1; 106/712; 501/17; 524/431

(57) ABSTRACT

The present invention relates to zinc ferrite pigments, to a process for producing them and to their use. It relates in particular to pale, yellow zinc ferrite pigments featuring enhanced reduction stability.

### BACKGROUND OF THE INVENTION

1. Field of the Invention

The present invention relates to zinc ferrite pigments, to a process for producing them and to their use. It relates in particular to pale, yellow zinc ferrite pigments featuring enhanced reduction stability.

Zinc ferrite pigments are used for industrial purposes.

Depending on stoichiometric composition, additives, particle sizes, crystal habit and surface properties, zinc ferrite, which crystallizes in the spinel lattice, can be used as a starting material for soft magnets, as a corrosion preventative or as a pigment.

“Tan” pigments is a term by which non-ferrimagnetic pigments have become known within the English-speaking sphere.

2. Brief Description of the Prior Art

U.S. Pat. No. 3,832,455 A1 describes the production of zinc ferrite pigments. A precipitate of iron oxyhydroxide from iron(II) sulphate solution on zinc oxide or zinc carbonate at pH values of 5 to 6 and temperatures of 49 to 52° C. is filtered and the solids are washed, dried, and calcined.

According to U.S. Pat. No. 2,904,395 A1 the zinc ferrite pigments are produced either by coprecipitation from the corresponding iron and zinc solutions, with subsequent filtration, washing, drying, and calcining, or else by calcining of an intimate mixture of iron oxyhydroxide and zinc oxide, obtained in aqueous suspension. Calcining takes place at temperatures up to 1000° C. with the addition of catalysts, examples being hydrochloric acid or zinc chloride.

U.S. Pat. No. 4,222,790 A1 describes how the calcining operation for producing zinc ferrite or magnesium ferrite can be improved by adding alkali metal silicate to the mixture. Aluminium sulphate can be added as a flocculant for the filtration.

The addition of compounds forming Al₂O₃ and P₂O₅ during the calcining of chloride-free, tinctorially pure zinc ferrite pigments is described in DE 31 36 279 A1.

Zinc ferrite pigments are also used as pigments for the paint industry.

Tinctorially pure zinc ferrite pigments without additives can be obtained according to EP 154919 A1 by using acicular α-FeOOH of defined particle size and surface area and zinc oxide of defined surface area. “Tinctorially pure” or else “saturated” colours are the pure spectral colours. By way of the shade the colour loses saturation, also referred to as whitening, until pure white is reached. (Compare, for example, “Vom Punkt zum Bild”, F. Bestenreiner, Wichmann Verlag 1988, ISBN 3-87907-164-0, page 61.) Tinctorially pure pigments are desired because they give the end user the perception of improved colour in the coloured test specimen.

JP 5 70 11 829 A produces heat-stable yellow zinc ferrite pigments by adding titanium oxide. Heat stability means that these pigments can be used in high-temperature applications in an inert or oxidizing environment (ceramic applications, for example) with minimal detriment to the colouring effect and with only a slight change in hue.

T. C. Patton, Pigment Handbook, Vol. 1, Properties and Economics, pp. 347 and 348, John Wiley & Sons, New York 1973, gives a general description of the zinc ferrite pigments obtained.

Since the aforementioned zinc ferrite pigments are distinguished by outstanding light stability and weather stability and also by high heat stability in an oxidizing environment, such as air or ceramics, for example, they are also used in place of less heat-stable mixtures of yellow iron oxide and red iron oxide. Consequently the zinc ferrite pigments of the prior art have found use in the colouring of sand granules, sand-lime bricks, enamels, ceramic glazes, baking varnishes, and plastics—in other words, principally in inert or oxidizing high-temperature applications.

Although the abovementioned zinc ferrite pigments are produced at high temperatures above 700° C., in different environments, particularly when colouring organic materials, they are subject to different degrees of colour change. In these systems, therefore, they can often no longer be regarded as reduction-stable. For instance, during the colouring of plastics such as HDPE it is found that the shift in hue towards darker, muddy shades is so marked, even above about 250° C., that colouring with zinc ferrite pigments is no longer sensible. This is especially the case with the colouring of plastics which require relatively high processing temperatures, such as polyamide or ABS plastics. This colour shift, characterized by the value ΔE*, is brought about by the reductive environment within the polymeric melt; the zinc ferrite pigments lack adequate reduction stability. Reduction stability for the purposes of this specification means that the colour shift ΔE* of the HDPE specimens, on raising of the incorporation temperature from 200° C. to 300° C., amounts to not more than 0.7 units.

“HDPE” is an abbreviation (according to DIN 7728, Part 1, January 1988, derived from the English term “high density polyethylene”) for high-density polyethylene, produced under low pressure. Instead of the abbreviation HDPE, the abbreviation PE-HD is being used increasingly today. As well as conventional HDPE, with molar masses of below 300 000 g/mol, high-density polyethylenes of higher molecular mass are on the market for speciality uses, and are referred to as “high molecular weight” HMW-HDPE (4·104<MR<3·105), “extra high molecular weight” (5·105<MR<1.5·106) and “ultra-high molecular weight” UHMW-PE (MR>3.1·106) (Römpp Lexikon Chemie—Version 2.0, Stuttgart/New York: Georg Thieme Verlag 1999).

DE 3 819 626 A1 describes the production of reduction-stable zinc ferrite pigments, a process for producing them and their use. Adding a lithium compound to an initial mixture of zinc oxide and iron oxide produces zinc ferrite pigments which contain lithium. These zinc ferrite pigments exhibit a colour shift ΔE* in HDPE to DIN 53 772 and DIN 6174 of 2.8, for specimens produced at 260° C. and at the very lowest-possible testing temperature (=200° C.) as reference. Processing temperatures of 300° C. produced a ΔE* value of 5.0 units. A disadvantage of these zinc ferrite pigments, however, is that they are too dark. When stoichiometric zinc ferrites are produced, however, these pigments are more than 1.5 L* CIELAB units (measured according to DIN 6174 in HDPE sample specimens prepared according to DIN 53772) darker in luminance and about 2 CIELAB units bluer in colour locus (characterized by a smaller b* value in the CIELAB colour system) than undoped zinc ferrite pigments.

It was an object of the invention to provide zinc ferrite pigments which combine unaltered reduction stability with greater lightness of colour and greater yellowness than reduction-stable zinc ferrite pigments according to the prior art.

### SUMMARY OF THE INVENTION

This object has been achieved by zinc ferrite pigments having an iron content≦66.4% by weight and a lithium content of at least 0.08% by weight. The methods of determining the iron content and lithium content are specified in the examples.

According to the state of the art to date the stoichiometric composition of zinc ferrite pigments, with an iron content of 66.6% by weight, is taken to be the colouristically optimum composition. If, however, zinc ferrite pigments with an iron content of 66.6% by weight are doped with lithium ions, the improvement in reduction stability is nevertheless accompanied by a marked impairment of the colour values.

If, however, the iron content is lowered to below 66.6% by weight, i.e. a low-iron and hence substoichiometric zinc ferrite is produced, it is found, surprisingly, that as a result of doping with at least 0.08% by weight of lithium the colour locus is increased by at least 1.5 CIELAB units in the luminance L* and in the yellow value b* in each case.

### DETAILED DESCRIPTION OF THE INVENTION

When incorporated into HDPE the zinc ferrite pigments preferably exhibit a colour shift ΔE* to DIN 53772 and DIN 6174 at 300° C. of <4.0, preferably of <3.0. The method of measuring the colour shift ΔE* is specified in the examples.

When incorporated into HDPE the zinc ferrite pigments preferably exhibit a colour shift ΔE* to DIN 53772 and DIN 6174 at 260° C. of <3.0, preferably of <2.4.

In HDPE sample specimens prepared in accordance with DIN 53772 the zinc ferrite pigments preferably exhibit an L* value in CIELAB units, measured in accordance with DIN 6174, of >51, preferably of >52. The method of measuring the L* value is specified in the examples.

In HDPE sample specimens prepared in accordance with DIN 53772 the zinc ferrite pigments preferably exhibit a b* value in CIELAB units, measured in accordance with DIN 6174, of >34, preferably of >35. The method of measuring the b* value is specified in the examples.

The invention also relates to a process for producing zinc ferrite pigments, characterized in that a raw material mixture, solution or suspension which produces or comprises an initial mixture of zinc oxide and iron oxide that corresponds to the composition of the zinc ferrite pigments is either
a) admixed before or during calcining with one or more lithium compounds, or
b) admixed after calcining with one or more lithium compounds and then calcined again,
or a combination of a) and b),
   so that, after calcining, 0.08% to 0.8% by weight of lithium is present in the zinc ferrite pigment and its iron content is ≦66.4% by weight.

Lithium compounds which can be used for the purposes of producing the reduction-stable zinc ferrite pigments of the invention are preferably lithium carbonate, lithium fluoride, lithium chloride, lithium oxide, lithium hydroxide, lithium sulphate, lithium nitrate, lithium phosphate, lithium silicate, lithium titanate, lithium zirconate, lithium ferrite, lithium zincate, lithium borate, lithium aluminate, lithium stannate, lithium aluminium silicate, and also further customary lithium salts or lithium salt-containing compounds.

For practical reasons it is preferred to use lithium carbonate in the case of dry mixtures and sparingly soluble lithium compounds in the case of suspensions still to be filtered. It is also possible with preference to use natural lithium-bearing minerals. Likewise possible with preference is the addition of organolithium compounds.

A substantial economic advantage of the process of the invention is that the low level of addition of lithium compounds allows the calcining temperature to be lowered by 50-100° C. This is also of environmental advantage, since it allows energy for producing the required reaction temperature to be saved.

The invention further provides for the use of the zinc ferrite pigments for colouring products of the ink, paint, coating, building material, plastic and paper industries, in foods, in baking varnishes or coil coatings, in sand granules, sand-lime bricks, enamels and ceramic glazes and in products of the pharmaceutical industry, preferably in tablets.

The required reduction stability in the context of plastics colouring (HDPE) is achieved for all zinc ferrite pigments having an iron content≦66.4% by weight. The zinc ferrite pigments of the invention can therefore be used much more effectively in the plastics processing industry than the prior art zinc ferrite pigments. The zinc ferrite pigments of the invention are particularly suitable for incorporation into polyamide or ABS plastics. With greater amounts of lithium in the zinc ferrite there is a surprisingly small shift of pigment hue towards darker brown shades, which makes the production operation much more stable, and hence features economic and environmental advantages over the prior art.

The subject matter of the present invention is apparent not only from the subject matter of the individual claims but also from the combination of the individual claims with one another. Similar comments apply to all of the parameters disclosed in the description and to their arbitrary combinations.

The examples below illustrate the invention, without any wish thereby to restrict the invention.

### EXAMPLES

I. Description of Measurement Methods Used

A. Determination of Iron Content

The iron content was measured by acid digestion and potentiometric titration in accordance with “Taschenatlas der Analytik”, G. Schwedt, Thieme-Verlag 1996, ISBN 3-527-30870-9 p. 50 ff. The measurement method has an accuracy of ±0.24% by weight.

B. Determination of Lithium Content

The lithium content was measured by atomic emission spectroscopy (see e.g. “Taschenatlas der Analytik”, G. Schwedt, Thieme-Verlag 1996, ISBN 3-527-30870-9 p. 94 ff.). The measurement method has an accuracy of ±0.001% by weight.

C. Reduction Stability/Colour Shift

The measurement of colour shift in a reductive environment (“reduction stability”) is made in HDPE in accordance with DIN 53772 of September 1981 by means of 1% pigmentation in HDPE, the colour deviation of the sample specimens being determined when the incorporation temperature is increased, in comparison to the lowest-possible test temperature of 200° C. ΔE* is determined for the samples produced at 300° C., 260° C. and 200° C. (200° C.=lowest-possible test temperature=reference) incorporation temperature in HDPE, in accordance with DIN 6174 of January 1979.

A spectrophotometer (“calorimeter”) having the d/8 measurement geometry, without a gloss trap, was used. This measurement geometry is described in ISO 7724/2-1984 (E), section 4.1.1, in DIN 5033 part 7 (July 1983), section 3.2.4 and in DIN 53236 (January 1983), section 7.1.1.

A SPECTRAFLASH FF 600+ instrument (Datacolor International Corp., USA) was employed. The colorimeter was calibrated against a white, ceramic working standard as described in ISO 7724/2-1984 (E) section 8.3 from 1984. The reflection data of the working standard against an ideally matt-white body are stored in the calorimeter, so that following calibration with the white operating standard all colour measurements are related to the ideally matt-white body. The black point calibration was performed using a black hollow body from the colorimeter's manufacturer.

D. Colour Measurement—Measurement of L* and b* Values

The result of colour measurement is a reflection spectrum. As far as the calculation of colorimetric variables is concerned it is immaterial what kind of light was used for measurement (except in the case of fluorescent samples). From the reflection spectrum it is possible to calculate any colorimetric variable. The colorimetric variables for the sample specimens used in this case are calculated in accordance with DIN 6174 of January 1979 (CIELAB values). Among other parameters, the colour values “L*” and “b*” are calculated in accordance with DIN 6174. For the perceived colour the following is the case: the more positive b*, the more yellowish the test specimen, and the greater L*, the lighter the perceived colour of the test specimen.

The sample specimens were prepared in HDPE in accordance with DIN 53772 of September 1981 (sections 7 to 9.2).

Any gloss trap present is switched off. The temperature of calorimeter and test specimen was approximately 25° C.±5° C.

II. Examples

### A. Example 1

783 g of a homogenized aqueous suspension containing 45 g of goethite and 23.7 g of zinc oxide (containing 99.8% by weight ZnO) are filtered, 0.73 g of lithium carbonate is added to the filtercake, which contains approximately 32% by weight of dry solids, the components are intimately mixed in an appropriate mixing assembly, and the mixture is calcined at 850° C. for approximately 30 minutes. After cooling, the clinker, which contains 0.2% by weight of lithium, is ground. This produces a light-coloured, bright yellow-brown pigment. Analysis of the clinker by acid digestion and potentiometric titration gave an iron content of 63.8%.

For the testing of the resulting pigment for reduction stability/colour shift:
a test specimen was prepared. In this case a pigmentation of 1% by weight in HDPE in accordance with DIN 53772 of September 1981 was incorporated in a twin-screw extruder and in the Arburg machine.
The colour shift was measured in accordance with DIN 6174 of January 1979. In this case a colour shift of 0.6 ΔE* units was measured for the samples produced at 260° C. and at the lowest-possible test temperature (=200° C.) as reference. At processing temperatures of 300° C. the result was 1.6 ΔE* units. The colour locus of the product at an incorporation temperature of 200° C. gave a luminance L* of 52.5 CIELAB units and a yellowness b* of 36.1 CIELAB units.

### B. Example 1—Comparative

In analogy to example 1 but without addition of lithium, the following properties were found:

For the testing of the resulting pigment for reduction stability/colour shift:
a test specimen was prepared. In this case a pigmentation of 1% by weight in HDPE in accordance with DIN 53772 of September 1981 was incorporated in a twin-screw extruder and in the Arburg machine.
The colour shift was measured in accordance with DIN 6174 of January 1979. In this case a colour shift of 0.6 ΔE* units was measured for the samples produced at 260° C. and at the lowest-possible test temperature (=200° C.) as reference. At processing temperatures of 300° C. the result was 1.6 ΔE* units. The colour locus of the product at an incorporation temperature of 200° C. gave a luminance L* of 50.8 CIELAB units and a yellowness b* of 33.3 CIELAB units.

### C. Example 2

783 g of a homogenized aqueous suspension containing 45 g of goethite and 23.7 g of zinc oxide (containing 99.8% by weight ZnO) are filtered, 1.46 g of lithium carbonate are added to the filtercake, which contains approximately 32% by weight of dry solids, the components are intimately mixed in an appropriate mixing assembly, and the mixture is calcined at 850° C. for approximately 30 minutes. After cooling, the clinker, which contains 0.4% by weight of lithium, is ground. This produces a light-coloured, bright yellow-brown pigment. Analysis of the clinker by acid digestion and potentiometric titration gave an iron content of 63.4%.

For the testing of the resulting pigment for reduction stability/colour shift:
a test specimen was prepared. In this case a pigmentation of 1% by weight in HDPE in accordance with DIN 53772 of September 1981 was incorporated in a twin-screw extruder and in the Arburg machine.
The colour shift was measured in accordance with DIN 6174 of January 1979. In this case a colour shift of 1.0 ΔE* units was measured for the samples produced at 260° C. and at the lowest-possible test temperature (=200° C.) as reference. At processing temperatures of 300° C. the result was 2.4 ΔE* units. The colour locus of the product at an incorporation temperature of 200° C. gave a luminance L* of 52.4 CIELAB units and a yellowness b* of 35.8 CIELAB units.

### D. Comparative Example 3

783 g of a homogenized aqueous suspension containing 45 g of goethite and 20.7 g of zinc oxide (containing 99.8% by weight ZnO) are filtered, 0.7 g of lithium carbonate is added to the filtercake, which contains approximately 32% by weight of dry solids, the components are intimately mixed in an appropriate mixing assembly, and the mixture is calcined at 850° C. for approximately 30 minutes. After cooling, the clinker, which contains 0.2% by weight of lithium, is ground. This produces a light-coloured, bright yellow-brown pigment. Analysis of the clinker by acid digestion and potentiometric titration gave an iron content of 67.3%.

For the testing of the resulting pigment for reduction stability/colour shift:
a test specimen was prepared. In this case a pigmentation of 1% by weight in HDPE in accordance with DIN 53772 of September 1981 was incorporated in a twin-screw extruder and in the Arburg machine.

The colour shift was measured in accordance with DIN 6174 of January 1979. In this case a colour shift of 2.5 ΔE* units was measured for the samples produced at 260° C. and at the lowest-possible test temperature (=200° C.) as reference. At processing temperatures of 300° C. the result was 4.1 ΔE* units. The colour locus of the product at an incorporation temperature of 200° C. gave a luminance L* of 50.5 CIELAB units and a yellowness b* of 33.7 CIELAB units.

TABLE 1

| | Iron | Lithium | | | L* value | b* value |
|---|---|---|---|---|---|---|
| | content | content | ΔE* at | ΔE* at | CIELAB | CIELAB |
| | % by wt | % by wt | 260° C. | 300° C. | units | units |
| Example 1 | 63.8 | 0.2 | 0.6 | 1.6 | 52.5 | 36.1 |
| Example 1 - comparative | 64.3 | <0.001* | 0.6 | 1.6 | 50.8* | 33.3* |
| Example 2 | 63.4 | 0.4 | 1.0 | 2.4 | 52.4 | 35.8 |
| Example 3 - comparative | 67.3* | 0.2 | 2.5 | 4.1* | 50.5* | 33.7* |
| Bayferrox ® 3950 from | 66.7* | <0.001* | 10.3* | — | 54.6 | 41.0 |
| Bayer | | | | | | |
| TAN ® 10 from Mapico | 66.8* | <0.001* | 5.9* | — | 52.9 | 37.5 |

*= property not meeting the requirements.

1. Zinc ferrite pigments having an iron content≦66.4% by weight and a lithium content of at least 0.08% by weight.

2. Zinc ferrite pigments according to claim 1, wherein when incorporated into HDPE the zinc ferrite pigments exhibit a colour shift ΔE* to DIN 53772 and DIN 6174 at 300° C. of <4.0, in particular of <3.0.

3. Zinc ferrite pigments according to claim 1, wherein when incorporated into HDPE the zinc ferrite pigments exhibit a colour shift ΔE* to DIN 53772 and DIN 6174 at 260° C. of <3.0, in particular of <2.4.

4. Zinc ferrite pigments according to claim 1, wherein in HDPE sample specimens prepared in accordance with DIN 53772 the zinc ferrite pigments exhibit an L* value in CIELAB units, measured in accordance with DIN 6174, of >51, in particular >52.

5. Zinc ferrite pigments according to claim 1, wherein in HDPE sample specimens prepared in accordance with DIN 53772 the zinc ferrite pigments exhibit a b* value in CIELAB units, measured in accordance with DIN 6174, of >34, in particular >35.

6. Process for producing zinc ferrite pigments according to claim 1, wherein a raw material mixture, solution or suspension which produces or comprises an initial mixture of zinc oxide and iron oxide that corresponds to the composition of the zinc ferrite pigments is either
a) admixed before or during calcining with one or more lithium compounds, or
b) admixed after calcining with one or more lithium compounds and then calcined again,
or a combination of a) and b),
so that, after calcining, 0.08% to 0.8% by weight of lithium is present in the zinc ferrite pigment and its iron content is ≦66.4% by weight.

7. Process of using the zinc ferrite pigments according to claims 1 or the zinc ferrite pigments obtained according to claim 6 to color products of the ink, paint, coating, building material, plastic and paper industries, foods, baking varnishes or coil coatings, sand granules, sand-lime bricks, enamels and ceramic glazes and products of the pharmaceutical industry, particularly in tablets, wherein the zinc ferrite pigments are mixed with the ink, paint, coating, building material, plastic and paper industries, foods, baking varnishes or coil coatings, sand granules, sand-lime bricks, enamels and ceramic glazes and/or products of the pharmaceutical industry.
